(19) United States
(12) Patent Application Publication
(10) Pub. No.: US 2016/0108899 A1
(43) Pub. Date: Apr. 21, 2016

(54) TWO-PHASE EXPANSION DEVICE CAPABLE OF MAXIMIZING THE AMOUNT OF MOVEMENT PRODUCED BY A TWO-PHASE FLOW

(71) Applicant: STOREWATT, Faucon de Barcelonnette (FR)

(72) Inventor: Claude FAVY, Faucon de Barcelonnette (FR)

(21) Appl. No.: 14/894,419

(22) PCT Filed: Jul. 9, 2014
(86) PCT No.: PCT/FR2014/051766

§ 371 Date: Nov. 27, 2015

(30) Foreign Application Priority Data
Jul. 10, 2013 (FR) 1301676

(51) Int. Cl. F03G 7/05; F01D 1/02; F01D 1/32

(52) U.S. Cl. CPC F03G 7/05; F01D 1/32; F01D 1/026; F05D 2210/13; F05D 2240/241; F05D 2240/242

(57) ABSTRACT

A two-phase expansion device (106) capable of maximizing the amount of movement produced by a two-phase flow. The two-phase expansion device (106) includes at least: one dispenser (105) for dispensing the fluid to a plurality of two-phase expansion nozzles (60); a plurality of adjacent two-phase expansion nozzles (60) with substantially parallel axes, each two-phase expansion nozzle (60) including sequentially at least one diffuser (65), one neck (66), and one tube (67), the two-phase expansion nozzles (60) being arranged to each receive a portion of the flow from the hot source; and elements for supporting the plurality of two-phase expansion nozzles (60) and including elements for sealably separating the two-phase expansion nozzles (60).

The present invention relates to a device allowing very efficient two-phase expansion of a significant saturation flow rate of a hot liquid with a low vapour density at the operating temperatures of the device. It applies quite particularly to the conversion of thermal energy to mechanical energy between a hot source and a cold source with a small temperature difference and more particularly to ocean thermal energy conversion (OTEC).

The conversion of thermal energy to mechanical energy, between a hot source at a moderate temperature and a cold source, with a small temperature difference, has long been a major challenge.

There are numerous configurations and there can be mentioned, as examples:
geothermal energy
industrial waste heat
ocean thermal energy conversion (OTEC), i.e. the temperature difference between the surface layers and the deep layers of the oceans, which can reach nearly 20° C. in the intertropical zones.

Numerous devices for converting this thermal energy to mechanical energy have been proposed, but there are still few industrial applications, in particular owing to the following points:
The small temperature differences between the hot source and the cold source mean a very low maximum theoretical degree of conversion of thermal energy to mechanical energy (of the order of 7% for OTEC).
The efficiency of the devices proposed is still very limited, which further reduces this degree of conversion.
Consequently, the volumes of fluid to be treated are extremely large, requiring very large heat exchangers.
Constraints connected with the marine environment in the case of OTEC.

The solutions proposed in the prior art can be classified as follows:
solutions that employ an organic Rankine cycle, i.e. in which the hot fluid derived from the hot source gives up its heat to a working fluid via an exchanger for vaporizing it. The working fluid expands through a turbine, supplying mechanical work, and is then condensed in a condenser, exchanging with the cold fluid from the cold source, and is finally pressurized by a pump. This so-called closed cycle offers the advantage that a working fluid can be used that has significant vapour volume densities at the temperatures considered, and therefore turbines of reasonable dimensions. However, it has major drawbacks, in particular the very large size of the heat exchangers between the hot and cold sources and the working fluid so as to be able to treat very significant flow rates with a minimum temperature pinch. There are appreciable risks of biofouling of these exchangers in the case of OTEC and the need to use working fluids such as ammonia also has real impacts on the environment.
solutions in which the hot fluid (generally water) is partially vaporized owing to its own specific heat (flash vaporization), its vapour is expanded in a turbine, where it supplies mechanical work, the vapour then being condensed due to heat exchange (most often direct) with the fluid from the cold source (generally water). This solution, called open cycle, has the advantage of avoiding having to resort to oversized heat exchangers between two different fluids. However, it has major limitations, in particular in the case of OTEC. In fact, in this case, the temperature of the hot source (about 28° C.) corresponds to extremely low vapour pressures of the order of 3 hundredths of a bar. At this pressure, the density of the vapour is very low and it is therefore necessary to pass an extremely large volume flow through the turbine, meaning both very large rotor diameters and high peripheral speeds. The centrifugal forces on the turbine components then become too large for powers starting from some MW (megawatts). Moreover, the inertia of the turbine also becomes very large, which may cause problems for connection to the power grid. This open cycle is therefore envisaged less and less for powers above a few MW.
The numerous devices using so-called two-phase turbines can also be mentioned. In this category, we may distinguish between:
   1. solutions in which the fluid is introduced in liquid form, expanded to form a vapour phase and a liquid phase, the two phases then being separated by means of a separator and each is expanded in separate devices, suitable for each phase. These solutions have great complexity and mediocre efficiencies.
   2. solutions in which the fluid is expanded through a nozzle, partially vaporizing as it leaves the nozzle, the liquid and vapour together then being expanded through a suitable nozzle. Taking into account the presence of a significant quantity of a liquid phase, any expansion in a turbine having changes of direction of the fluid is ill-advised, otherwise the blades could deteriorate rapidly. The solution that remains is the “Hero” type single-stage reaction turbine. In this type of turbine, in order to maintain good efficiency it is necessary for the absolute velocity of the fluid leaving expansion to be as low as possible. Now, the fluid ejected is at most 95% by weight in liquid form, whereas the mass of the vapour part remains very low. However, it is the vapour which, by transforming its enthalpy to kinetic energy during expansion, accelerates much more than the liquid part. The two phases, which have very little mechanical coupling in the proposed devices, will therefore have very different velocities at the outlet from expansion, which is incompatible with good efficiency of the turbine.
      To date, no device of this type has been proved to be efficient, and no device has been designed specifically for the area of low temperatures of the hot source, the fluid being water, taking into account its very low vapour density.
Solutions in which hot water undergoes flash vaporization, its vapour being expanded in a vertical diverging portion, where it transfers part of its energy to liquid water so as to lift this water in the device against gravity. These solutions make it possible to avoid the heat exchangers of the closed-cycle type and the oversized turbines of the open-cycle type mentioned above. The solutions proposed are in particular:
   1. in the form of bubbles, as described in document U.S. Pat. No. 3,967,449, in which bubbles of vapour are produced in the liquid phase so as to lower the density of the whole. With this device there is considerable difficulty in maintaining the pressure conditions necessary for the formation of bubbles in the liquid phase.
   2. in the form of foam, as described in document U.S. Pat. No. 4,249,383, in which a foam composed of vapour, hot water and a foaming agent is formed and is lifted by the vapour. The need to use a foaming agent and the difficulty in maintaining the stability of the foam seem prohibitive.
   3. in the form of drops, as described in document U.S. Pat. No. 4,216,657, in document U.S. Pat. No. 4,441,321 (inventor Stuart L. Ridgway) or in patent application US 2013/0031903, in which drops or microdrops are lifted by their own vapour in a vertical chamber (mist-lift technique).
      The energy is recovered by simple hydraulic turbining of the liquid phase.
      The term “mist-lift” will denote hereinafter the method by which droplets of hot fluid are lifted against gravity by their own vapour under the effect of the difference in vapour pressure between the hot lower part and the cold upper part of the device.

Although simple, the proposed device, employing the mist-lift technique, has a certain number of drawbacks, and in particular:
The need for a very large section for passage of the vapour, taking into account the very low density of the vapour and its necessarily limited initial velocity associated with a very significant height. As an example, a 4-MW device of this type for OTEC would have a diameter of 20 m for a height of nearly 100 m, causing considerable difficulties in implementation, operation and cost.
Large energy losses through collision of the droplets with the walls or between each other, on account of the very large vertical distance to be traveled.
The mist generator proposed is of low efficiency with significant energy loss during initial flash vaporization and inefficient vapour/droplets coupling during the acceleration phase, associated with significant pressure drops, these factors taken together leading to very limited overall efficiency of the device.
Difficulties in recovering the energy of the droplets accelerated in an efficient conversion device.

The device according to the invention makes it possible, among other things, to provide a response to the difficulties associated with the devices proposed in the prior art, by proposing a solution suitable for efficient two-phase expansion of a fluid at low temperature in which the dispersed phase consists of drops of very small dimensions (with diameter from about ten microns to a few millimetres), therefore called droplets, microdrops or even microdroplets, and the continuous phase of its own vapour, the fluid having very low vapour density at the temperature considered (for example water at 28° C.). It makes it possible to obtain good mechanical coupling between the vapour and the droplets and to accelerate the droplets very efficiently, limiting the pressure drops of the flow. The device can be incorporated in an energy conversion device using the mist-lift technique or in a rotating machine utilizing the reaction due to the two-phase jet.

In the text, mist denotes a mass of droplets (several millions or billions per m³) dispersed in the vapour generated by their own partial evaporation.

According to a first aspect, the invention proposes a two-phase expansion device capable of maximizing the momentum produced by a two-phase flow originating from the expansion of a significant saturation flow rate of a fluid coming from a so-called hot source. The two-phase expansion device comprises at least:
one distributor making it possible to distribute the fluid coming from the hot source to a plurality of two-phase expansion nozzles;
a plurality of adjacent two-phase expansion nozzles with substantially parallel axes, each nozzle comprising successively at least one converging portion, one neck and one tube and the nozzles being arranged so that each receives a portion of the flow originating from the hot source;
means making it possible to hold the plurality of two-phase expansion nozzles in place and comprising impervious separating means between the two-phase expansion nozzles.

The two-phase expansion device thus makes it possible, in particular, both to work with significant flow rates owing to the use of the plurality of two-phase expansion nozzles, while controlling the expansion of the vapour during expansion, the source of loss of pressure and therefore of efficiency.

The two-phase expansion device can have the following features, alone or in combination:
the section of the neck of at least one two-phase expansion nozzle is designed to produce a liquid jet;
the section of the neck of the at least one two-phase expansion nozzle for producing a liquid jet is of circular or square shape;
the section of the neck of at least one two-phase expansion nozzle is designed to produce a liquid sheet;
the section of the neck of the at least one two-phase expansion nozzle for producing a liquid sheet is in the form of an elongated slit;
at least one of the two-phase expansion nozzles contains a mixer element downstream of the neck;
all of the expansion of the saturation flow rate is carried out in each of the two-phase expansion nozzles;
only a portion of the expansion of the saturation flow rate is carried out in each of the two-phase expansion nozzles, the rest of the expansion being carried out in a common diverging forming duct extending the assembly of two-phase expansion nozzles;
the space between the two-phase expansion nozzles at the tube outlet is minimized by means of a suitable nozzle outlet geometry, so that the outlet of the tube of a first two-phase expansion nozzle is in contact with the outlet of the tube of a second two-phase expansion nozzle adjacent to the first two-phase expansion nozzle;
liquid originating from a so-called cold source, at a temperature below that of the hot source, and intended to condense the vapour produced is ejected in the form of spray from the available space between the two-phase expansion nozzles at the outlet of the tube of the two-phase expansion nozzles with a high velocity component in the direction of the two-phase flow leaving the two-phase expansion nozzles;
the two-phase expansion device contains extending elements of variable section at the outlet of the tube of the two-phase expansion nozzles, providing continuity of the variation of section of the two-phase flow from the outlet of the tube of the two-phase expansion nozzles to the outlet of the common diverging forming duct that extends the two-phase expansion nozzles;
liquid originating from a so-called cold source, at a temperature below that of the hot source, and intended to condense the vapour produced, is ejected in the form of spray from the extending elements with a high velocity component in the direction of the two-phase flow leaving the duct extending the tube of the two-phase expansion nozzles;
the means making it possible to hold the plurality of two-phase expansion nozzles in place comprise a plate, the two-phase expansion nozzles being machined to fit the plate or moulded with the plate;
the means making it possible to hold the plurality of two-phase expansion nozzles in place comprise means for welding or for bonding the two-phase expansion nozzles together.

According to a second aspect, the invention proposes a turbine of the “Hero” type containing at least one two-phase expansion device as presented above, at the end of at least one of its arms.

According to a third aspect, the invention proposes a turbine of the impulse type containing at least one two-phase expansion device as presented above, used as an injector.

According to a fourth aspect, the invention proposes an energy conversion device using the mist-lift technique containing at least one two-phase expansion device as presented above for producing and accelerating the droplets of hot liquid, said conversion device using the mist-lift technique comprising means for fluidic connection with a hot source and means for fluidic connection with a cold source. The hot source is for example hot water at a first depth under the surface of the ocean and the cold source is cold water at a second depth greater than the first depth under the surface of the ocean.

The attached drawings illustrate particular embodiments of the invention:

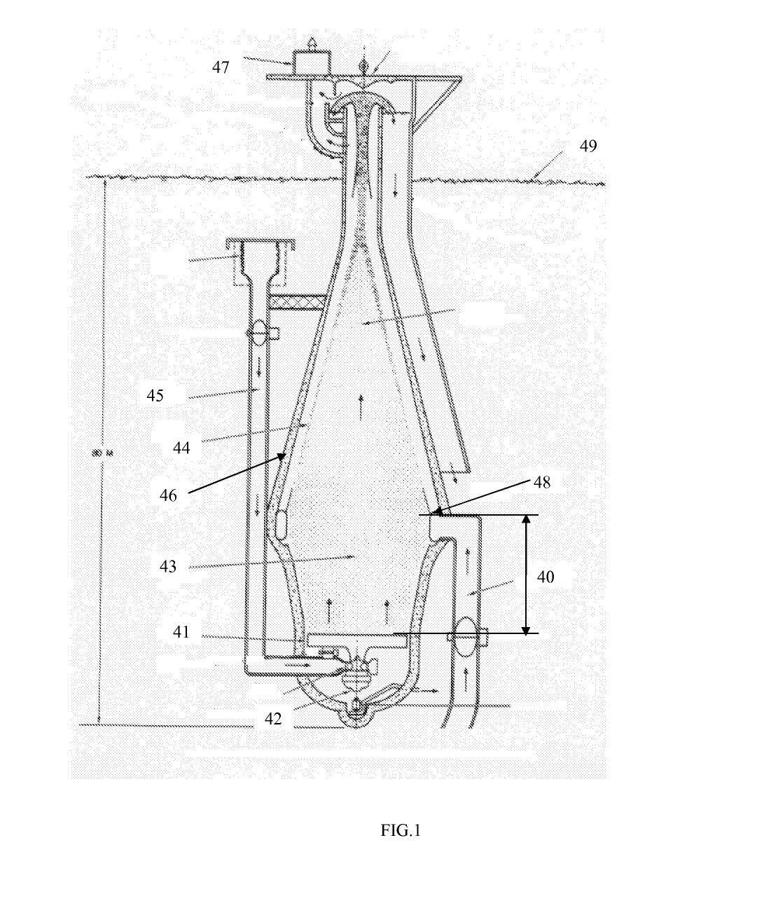

FIG. 1 shows, from the prior art, a diagram representing the mist-lift device as presented in U.S. Pat. No. 4,441,321;

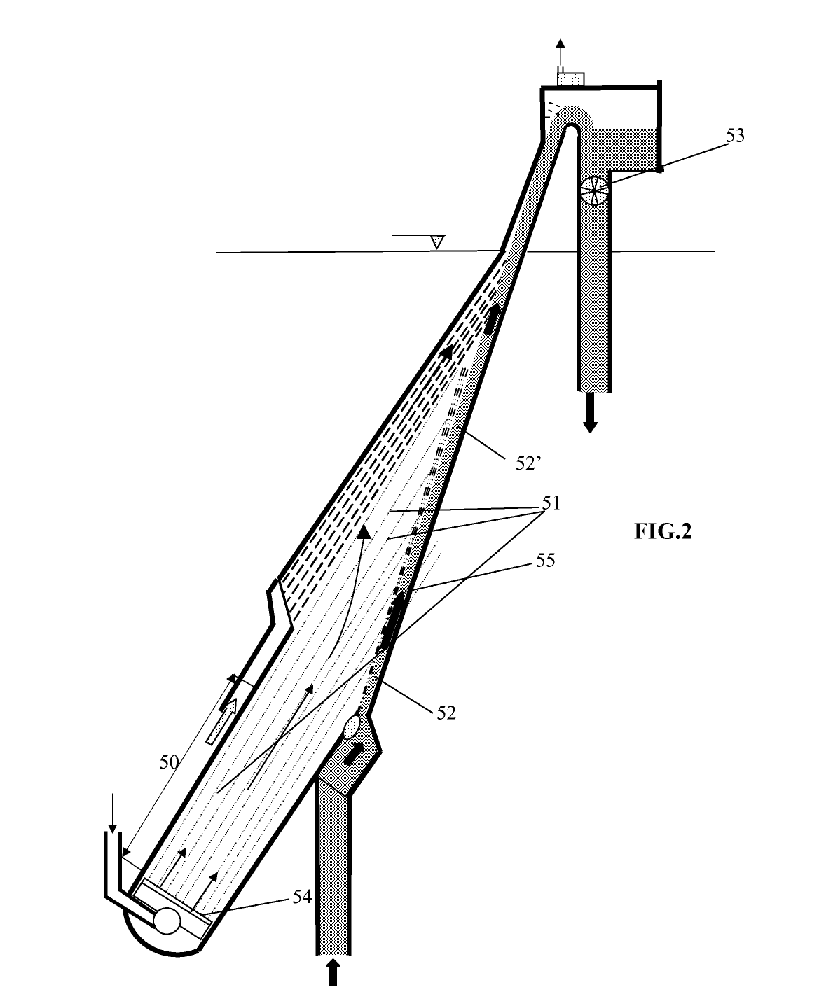

FIG. 2 shows, from the prior art, a diagram representing a device for the mist-lift technique;

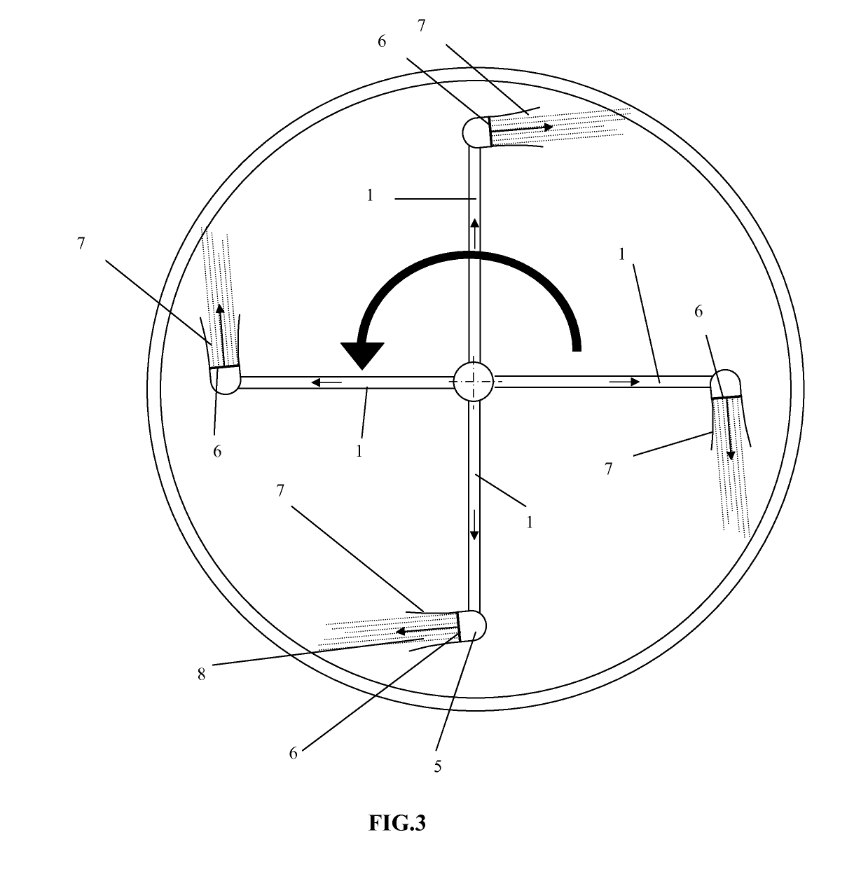

FIG. 3 shows, from the prior art, a diagram representing a turbine of the “Hero” type, each arm having a mist accelerator;

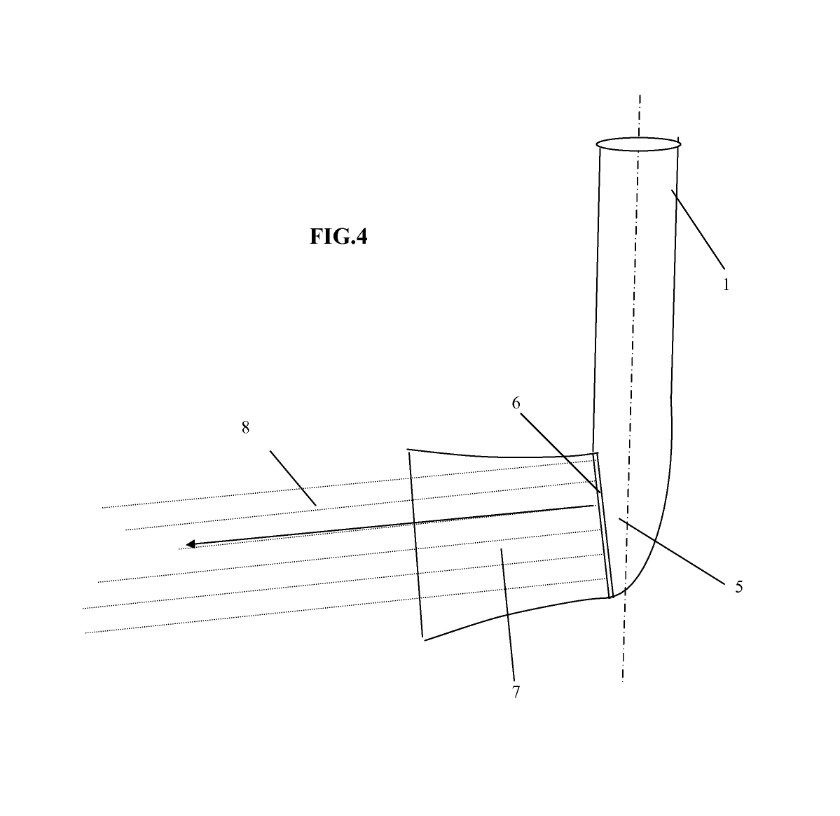

FIG. 4 shows a diagram representing a detailed view of the end of the arm of the “Hero” turbine shown in FIG. 3;

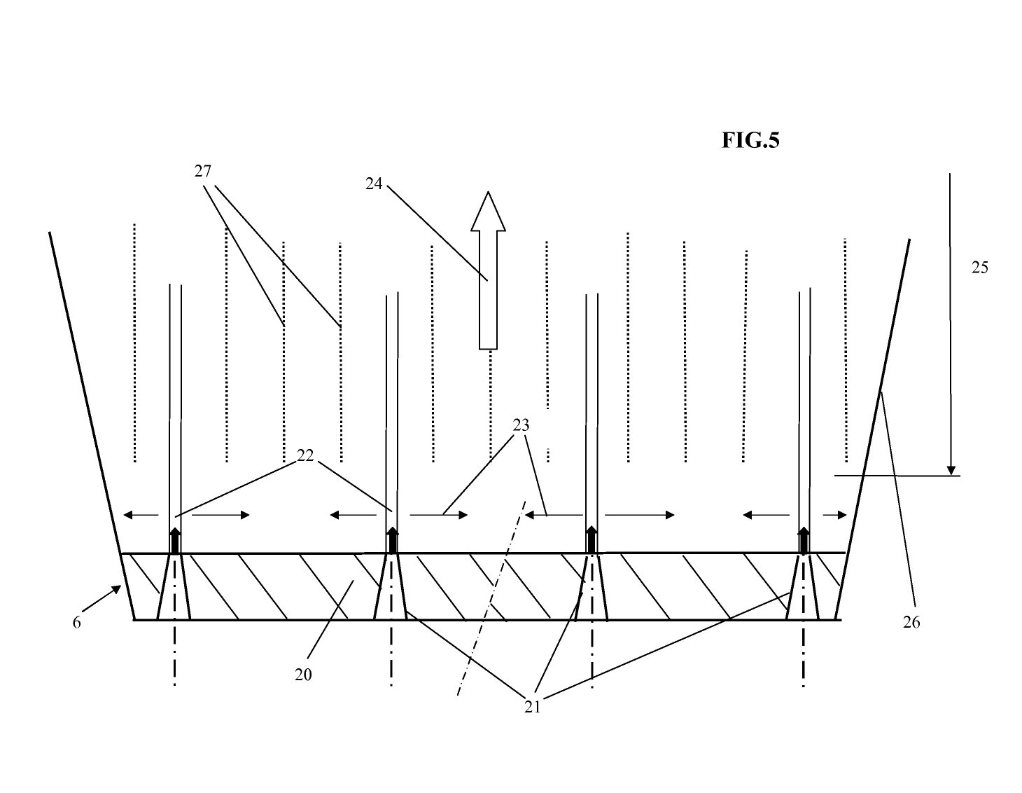

FIG. 5 shows, from the prior art, a diagram representing a vertical sectional view of the mist generator part of the devices shown in the preceding figures;

FIG. 6 shows, from the prior art, a schematic diagram of a two-phase expansion nozzle;

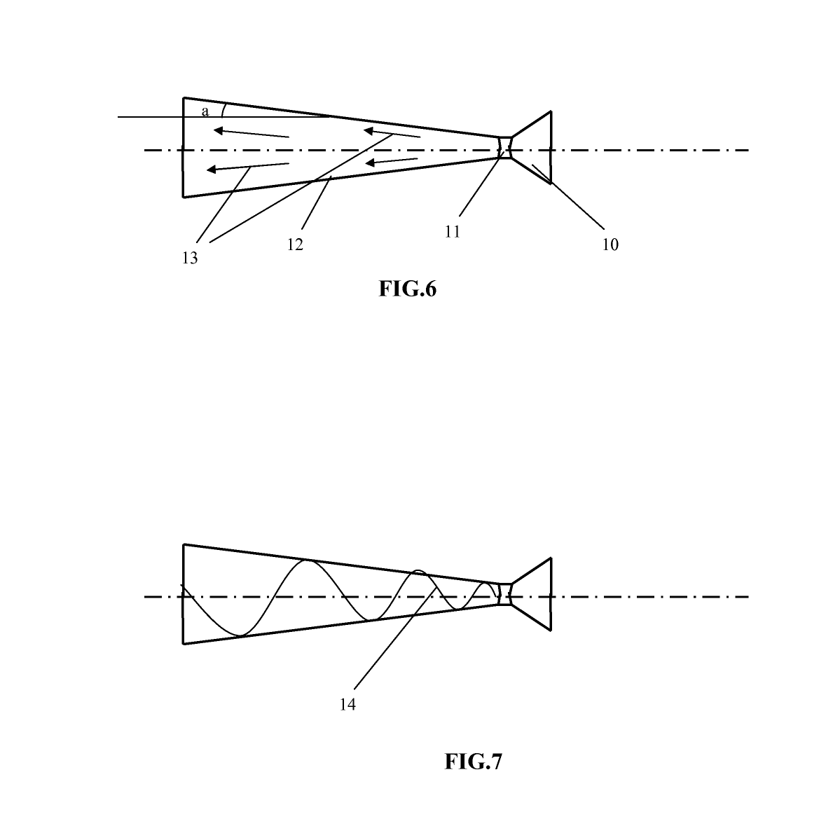

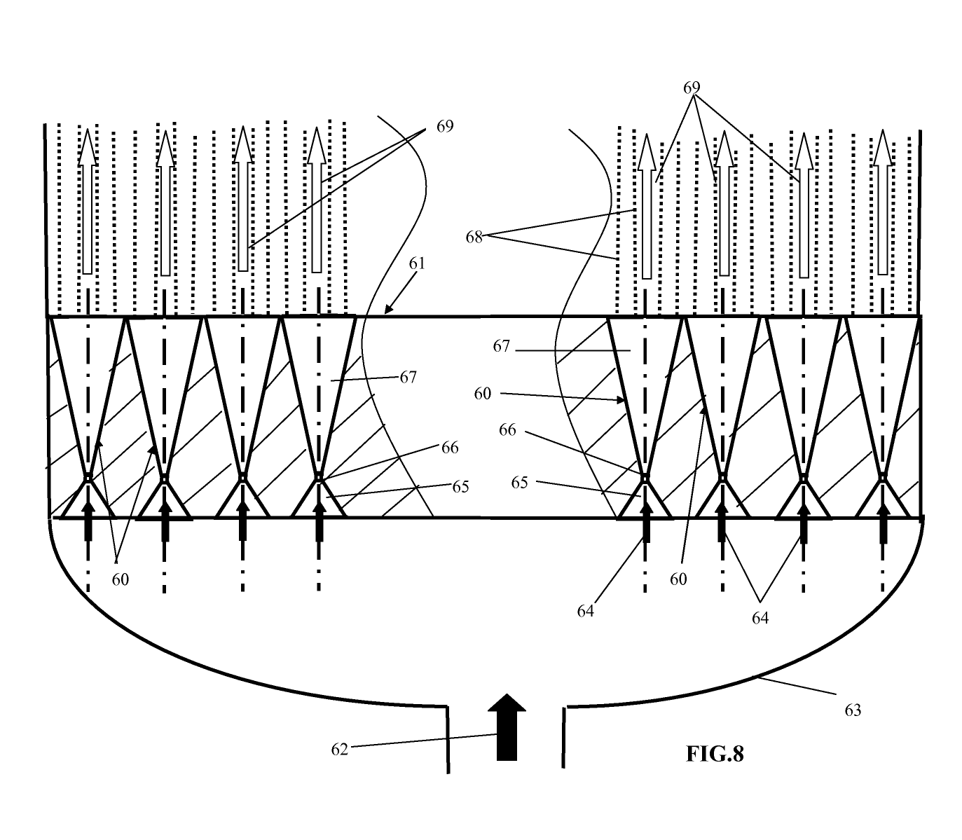

FIG. 7 shows, from the prior art, a schematic diagram of a two-phase expansion nozzle comprising a mixer element as presented in document FR 2 944 460;

FIG. 8 shows an embodiment of the two-phase expansion device of the present invention, the whole of the expansion being carried out in a plurality of two-phase nozzles;

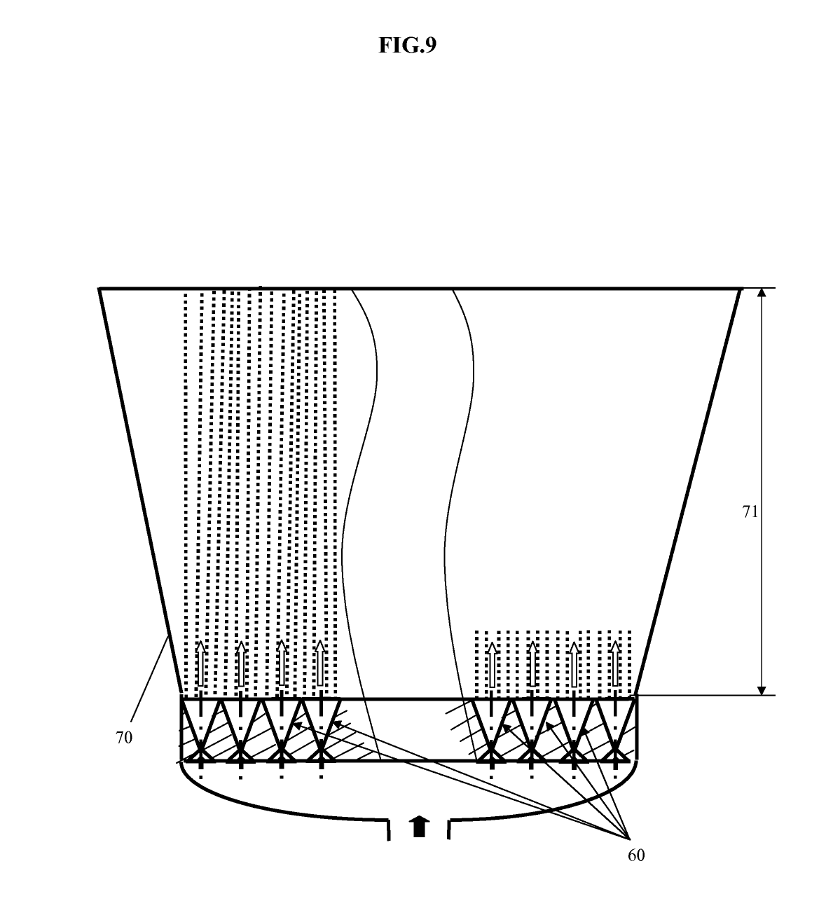

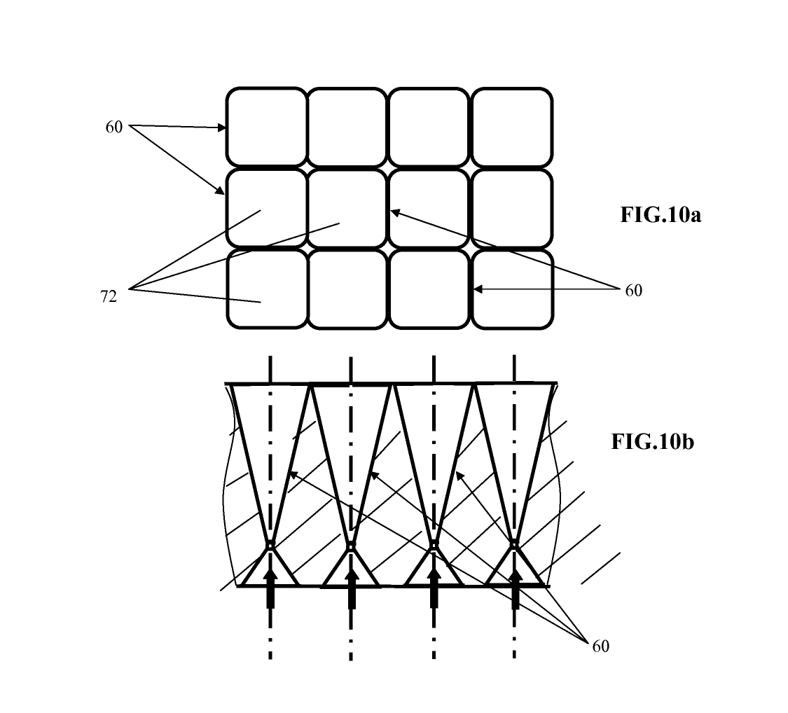

FIG. 9 shows an embodiment of the two-phase expansion device of the present invention, one part of the expansion being carried out in a plurality of two-phase nozzles and the other part in a suitable duct;

FIGS. 10a and 10b show respectively a partial top view and a partial sectional view of an embodiment of the two-phase expansion device of the present invention, the space between nozzles at the outlet of the nozzles being minimized;

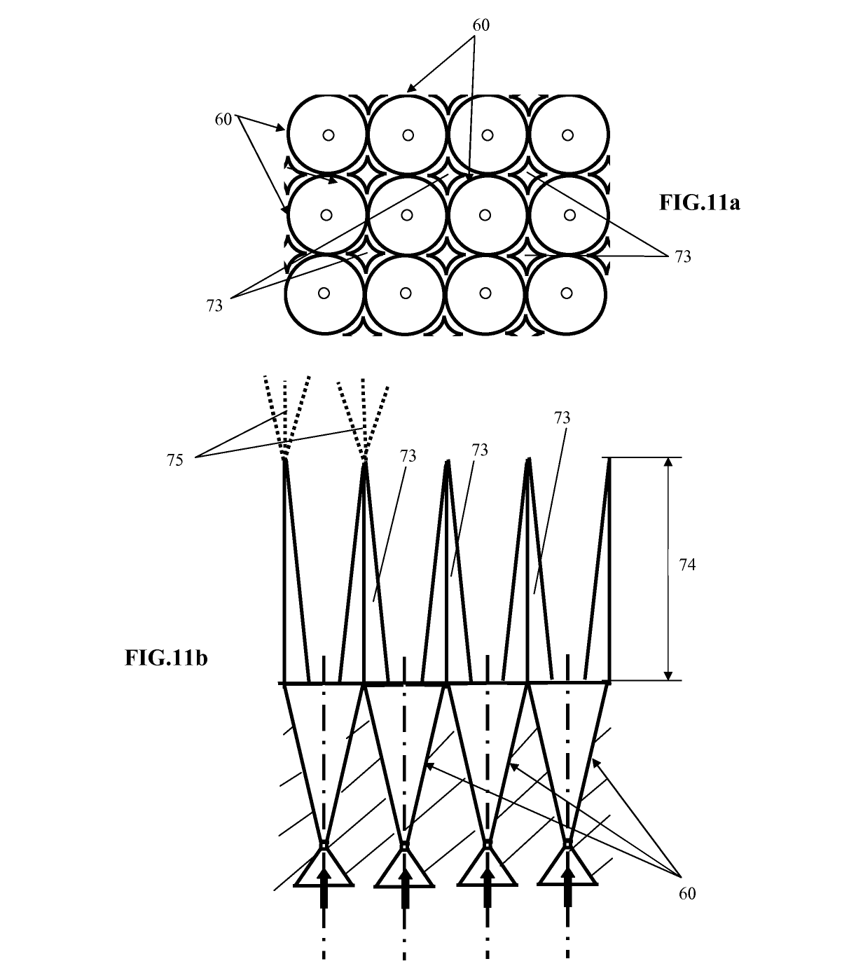

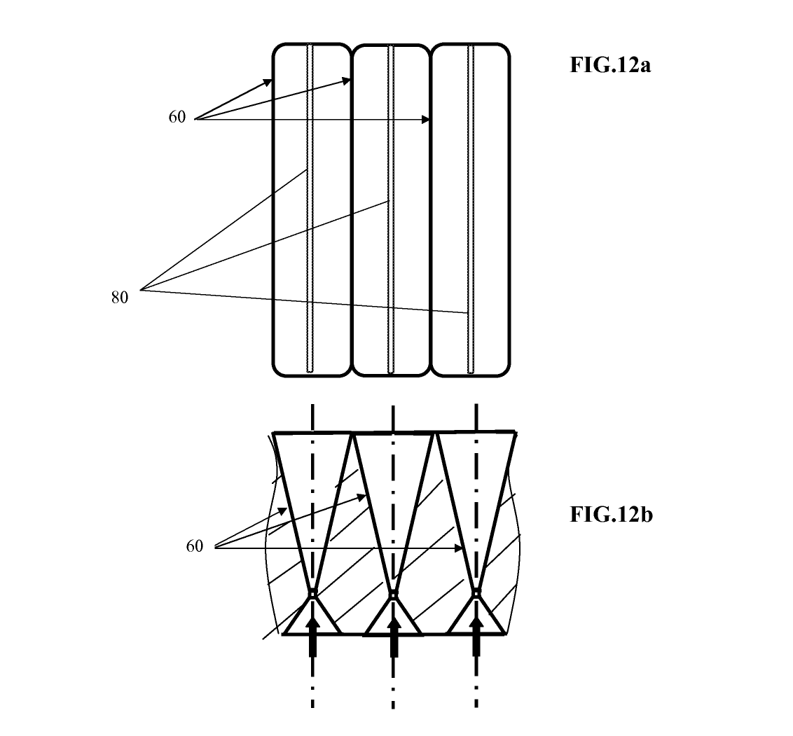

FIGS. 11a and 11b show respectively a partial top view and a partial sectional view of an embodiment of the two-phase expansion device of the present invention, extending elements being inserted in the duct extending the nozzles;

FIGS. 12a and 12b show respectively a partial top view and a partial sectional view of an embodiment of the two-phase expansion device of the present invention, a liquid sheet being generated at the outlet of the neck of the nozzles;

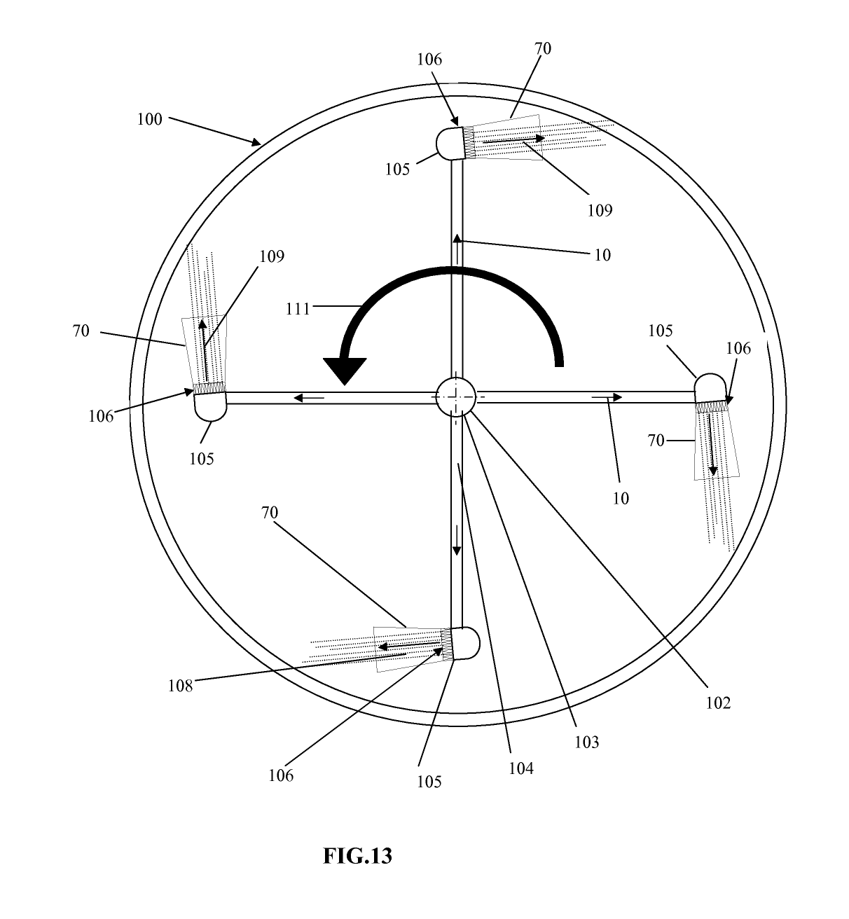

FIG. 13 is a cross-sectional view of an embodiment example of a device for the conversion of thermal energy to mechanical energy using a turbine of the “Hero” type, which is equipped with a two-phase expansion device according to FIG. 9;

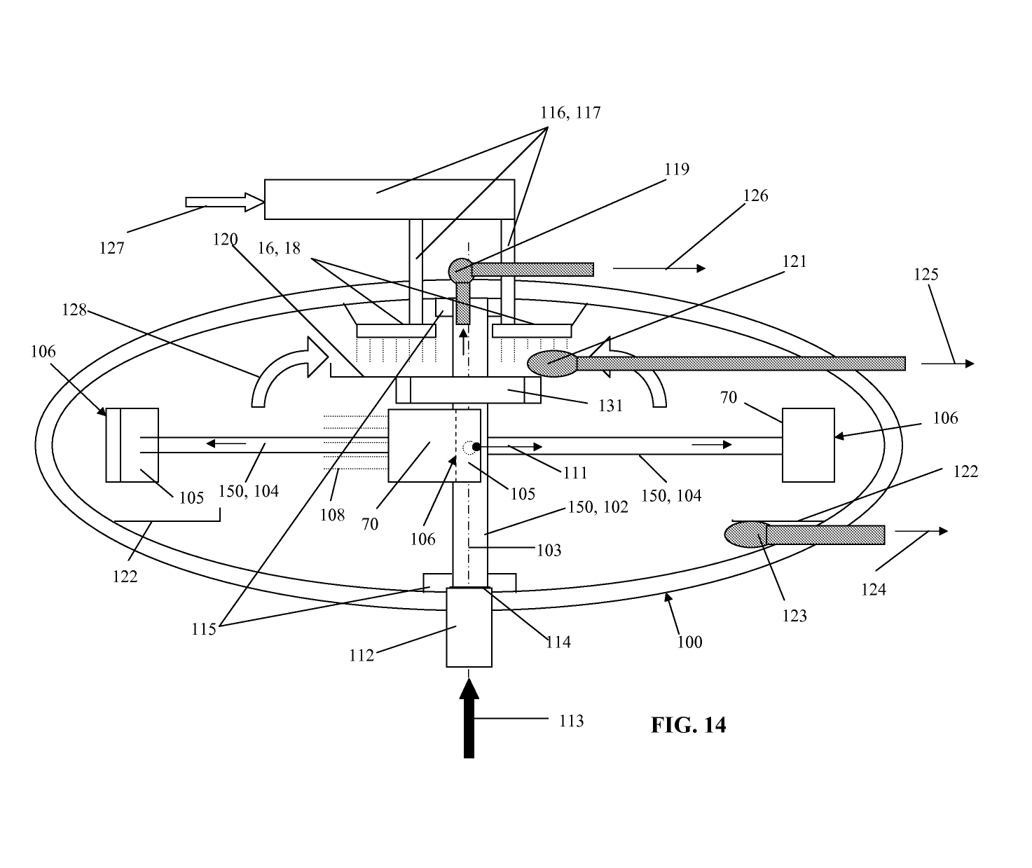

FIG. 14 is a longitudinal sectional view of the conversion device of FIG. 13;

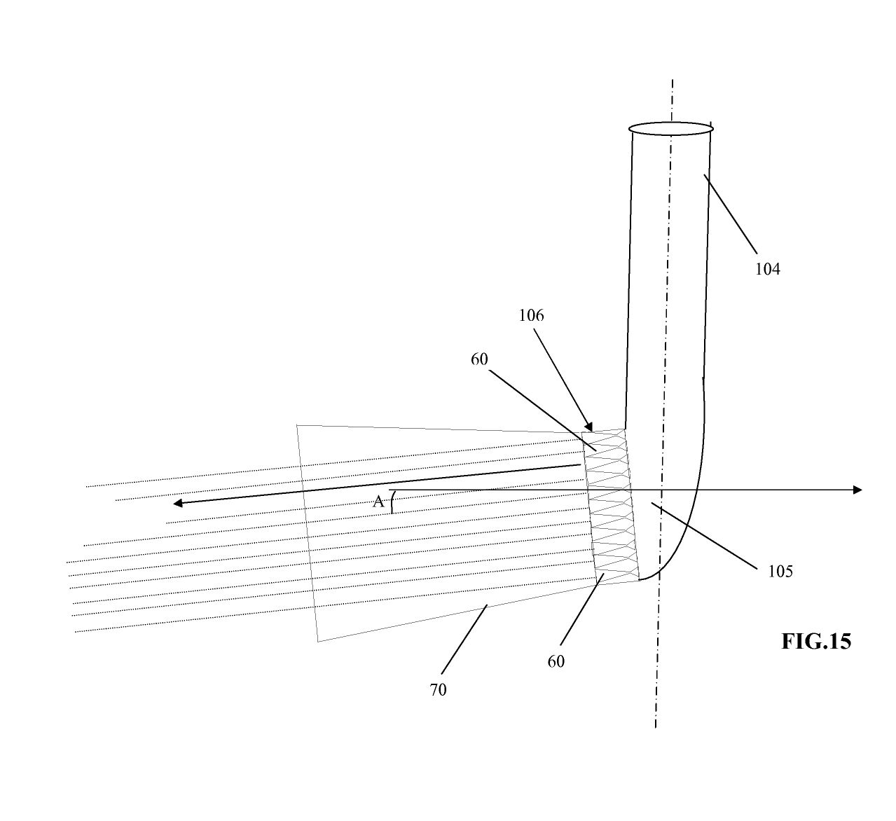

FIG. 15 is a detailed top view of the end of an arm of the turbine of the “Hero” type in FIGS. 13 and 14;

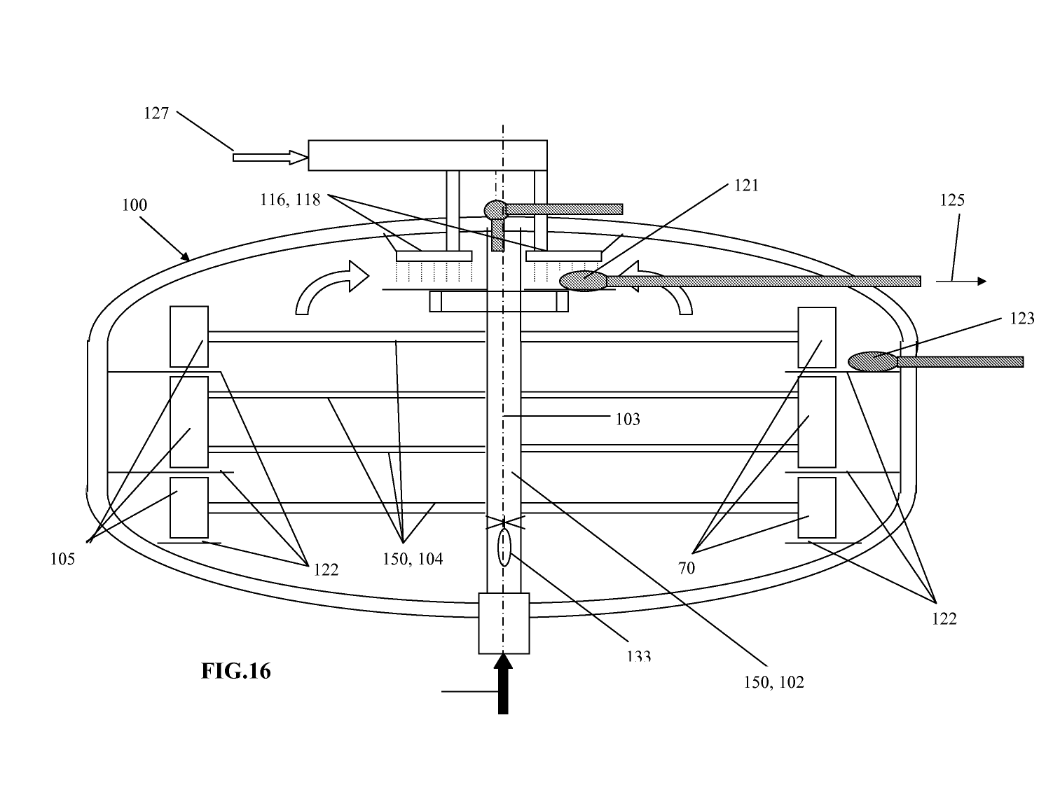

FIG. 16 is a view similar to that of FIG. 14, for a variant embodiment of the conversion device.

For easier understanding of the application, the devices shown and described in the various figures are adapted for OTEC, namely the hot fluid designated as hot water is in this case seawater extracted at the surface at a temperature that can in general vary between 22° C. and 30° C. and the cold fluid designated as cold water is seawater extracted from depths (generally a depth of between 500 and 1500 m) and at a temperature between about 5° C. and 10° C., conditions that are found for example in the oceans of the intertropical zones.

The devices described could of course operate in a context other than OTEC with hot and cold fluids different from seawater (for example with geothermal energy and hot water derived from the subsoil and cold water originating from a river, or with recovery of industrial waste heat) or at temperatures appreciably different from those stated provided the device has adaptations that are obvious to a person skilled in the art. The present patent application comprises these other uses and/or other fluids.

The following table gives examples of temperature levels of recoverable heat, i.e. the temperature of the hot fluid, in various industrial applications in which the device of the present invention could be used.

| | | | | Diesel | Diesel |
|---|---|---|---|---|---|
| | | Cement | Aluminium | engine | engine |
| | Steelworks | works | works | exhaust | cooling |
| Temperature | 350 | 300 | 180 | 350 | 90 |
| (° C.) | | | | | |

FIG. 1 shows the mist-lift technique described in document U.S. Pat. No. 4,441,321.

Hot water 45 taken near the surface 49 of the ocean is ejected with an ascending vertical velocity by a mist generator 41 allowing a multitude of microdroplets 43 to be produced in a chamber 46 in which a high vacuum is maintained.

The droplets 43 are partially vaporized under the effect of the vacuum (flash vaporization). The vapour is then expanded in a vertical diverging portion where it transfers a portion of its energy to the water droplets, lifting them against gravity in an acceleration zone 40.

Cold water pumped from the depths, i.e. at a depth greater than that of the hot water 45, is injected along the walls at mid-height of the chamber 48 in the form of spray 44 with an initial ascending velocity. This spray is itself entrained upwards by the combination of hot water droplets and vapour.

This cold water spray makes it possible to condense the vapour gradually in the upper part of the chamber 46.

The combination of cold water spray, hot water droplets and remaining vapour converges at the top of the chamber 46 to form a liquid jet. The liquid part is discarded into the ocean.

A vacuum pump 47 evacuates the non-condensables from chamber 46.

The energy of the device is recovered by means of a hydraulic turbine 42 installed in the hot water feed channel.

Although simple, this device has the drawback of requiring very large sections for passage of vapour, combined with very significant heights. In fact, taking into account the very low density of the vapour and its necessarily limited initial velocity, the pressure upstream of the mist generator is reduced by the pressure drop due to the hydraulic turbine. By way of example, a 4-MW device of this type for OTEC would have a diameter of 20 m for a height of nearly 100 m.

The combination of mist generator and acceleration zone constitutes one of the key elements of the device, as it is a question of transforming the thermal energy contained in the water into kinetic energy for the vapour (by expansion), in its turn transferred to a large extent to the droplets by the vapour.

Experiments with a height limited to 4 m were carried out for validation of the concept by Stuart L. Ridgway and a detailed analysis of the results obtained does not allow the concept to be validated, with only the pressure drops of the vapour along its path having been measured and the assumption having been made that this pressure drop corresponded to the energy transferred to the droplets in the form of upward kinetic energy. Other experiments carried out by a Japanese team (“A fundamental study of the mist lift cycle” by Nagasaki, Hijikuta, Mori and Sakurai) also do not validate the concept, the authors having undertaken analysis of the evolution of the diameters of the droplets, the accelerations obtained remaining low. A purely theoretical simulation of the concept indicates extremely high pressure drops in the combination of mist generator and acceleration zone.

The device according to the invention constitutes a new concept of the combination of mist generator and acceleration zone and in particular allows its efficiency to be improved.

Returning to FIG. 1, once they have passed the acceleration zone, the droplets must travel a long distance in chamber 46 with a very high probability of collision between the droplets themselves or with the walls. In fact, although homogeneous initially, the dimensions and the velocities of the droplets become more and more heterogeneous as a result of the collisions and phenomena of coalescence, leading to different droplet velocities.

Each collision constitutes an energy loss for the device. There will be a significant loss as a result of these collisions. There will be little if any entrainment of the largest droplets by the vapour, and they risk dropping down in the chamber. Convergence of the droplets to form a single jet will not be possible without a significant energy loss. Moreover, the contact surface between cold water spray and vapour must be very significant, requiring fine atomization of the cold water spray in order to obtain the thermal exchanges necessary for the complete condensation of the vapour by the cold water. Under these conditions, the collisions of the droplets making up the cold water spray and of the hot water droplets then being transformed into a single liquid jet consumes a lot of energy (successive collisions).

It is also important to mention the problems of stability of the cold water spray. It is in fact a free spray, unsupported and not guided against the effect of gravity by any wall. It will therefore necessarily have a tendency to move away from the wall of the device under the effect of gravity.

FIG. 2 shows, from the prior art, a variant of the mist-lift technique in which transmission of the kinetic energy of the hot water droplets 51 takes place by incorporation in a liquid sheet 52 flowing on a wall 55, making it possible to reduce the height of the device above an acceleration zone 50 and improve the transition from dispersed droplets 51 to a single-phase liquid jet 52′ that can be turbined by a turbine 53.

However, the arrangements proposed for the mist generator 54 and the droplet acceleration zone 50 remain identical to those proposed by Stuart L. Ridgway.

FIG. 3 shows, from the prior art, a “Hero” turbine with four arms 1 mounted in rotation in a chamber, specific to a fluid having a very low vapour density at the expansion temperatures considered. Each arm 1 makes it possible to feed hot water at its end to a combination of mist generator 6 and acceleration zone, the latter being for example in the form of a nozzle 7. Once again, the arrangements proposed for the mist generator 6 and the acceleration nozzle 7 are the same as those proposed by Stuart L. Ridgway for the mist-lift method.

FIG. 4 shows, from the prior art, a detailed view of the end of arm 1 of the “Hero” turbine in FIG. 3. Hot water under pressure supplies a receiver 5 and then passes through the mist generator 6. The two-phase fluid is then accelerated in nozzle 7. The outgoing jet 8 propels, by reaction, the combination of generator 6 and nozzle 7, causing rotation of the arms 1 in the chamber.

FIG. 4 shows the end of one of the arms 1, comprising the receiver 5, followed by the generator 6 and the nozzle 7, oriented so that the jet leaving the nozzle 7 is substantially perpendicular to the axis of rotation of the arms 1.

FIG. 4 shows, from the prior art, a detailed partial sectional view of the mist generator 6 proposed in the mist-lift or “Hero” turbine concepts described previously.

The mist generator 6 proposed in the prior art must make it possible to comply with the constraints specific to OTEC, namely considerable quantities of hot water and extremely low vapour densities. By way of example, a 10-MW OTEC power station must treat a flow rate of hot water of about 20 m³/s. Each cubic metre of hot water will produce about 240 billion droplets 27 with diameter of 200 microns and will generate 930 m³ of vapour at the end of expansion. The mist generator 6 consists of a plate 20 perforated with a plurality (several millions) of injection holes 21 of convergent shape in which the water is accelerated under the effect of the pressure. As an example, the holes, with a diameter of 100 microns, are spaced 2 mm apart, i.e. 250 000 holes per m², a 10 MW power station requiring a plate area of 350 m². A liquid jet 22 forms at the outlet of each hole 21 in plate 20, the diameter of the jet being substantially equal to the diameter of the outlet of hole 21. On leaving the hole 21, this jet is suddenly depressurized to a pressure below its vaporization pressure. There is therefore, very suddenly, initial creation of vapour (less than 1% by weight) and the jet breaks up into droplets with diameter substantially equal to twice the diameter of the jet, the thermal energy required for vaporization being supplied by the sensible heat of the water (flash vaporization). The initial creation of the vapour takes place perpendicularly to the jet following the arrows 23, so as to fill the available volume between the holes 21 with the vapour. At best, this phase of creation of vapour does not do any useful work on the droplets, entraining them in a direction perpendicular to the desired direction of the jet. Experiments have in fact shown a slowing of the initial velocity of the droplets in the direction of the jet in this phase, the sudden creation of vapour leading to considerable turbulence in this zone. This energy is therefore lost to the device. It is therefore necessary to limit this initial creation of vapour to a portion of the thermal energy available in the droplets. The vapour 27 is then entrained following the arrow 24, under the effect of the pressure difference between the hot injection zone and a zone that is kept cold with water from the cold source, in an acceleration zone 25 formed from a diverging nozzle 26, corresponding to nozzle 7 in FIG. 4, common to the holes 21 in plate 20, where the vapour expands and transforms the remaining enthalpy into kinetic energy. In this common nozzle 26, the droplets continue to cool down and produce vapour. There, the kinetic energy of the vapour is transmitted partly to the droplets under the effect of the frictional forces between vapour and droplets, which are accelerated.

Thus, the expansion of the vapour in its entirety is completed in the acceleration zone 25 of the common nozzle 26, so that the assembly comprising the plate 20 and the acceleration zone 25 forms a single expansion nozzle the inlet of which is formed by the holes 21, and the outlet of which is formed by the outlet of the acceleration zone 25.

A detailed analysis of the results obtained in various experiments of this type of device applied to ocean thermal energy shows a very low overall efficiency of the device.

Several reasons can be mentioned:
1. The section on the path of the jet changes abruptly, from the outlet of the injection hole 21 to the acceleration zone 25, where expansion of the vapour 27 takes place perpendicularly to the velocity of the jet (the section changes abruptly from the section of the hole to a section that is 500 times larger). This expansion of vapour 27 not only does not transmit kinetic energy to the droplets in the desired direction, but it breaks up the jet into a multitude of droplets entrained perpendicularly to the jet. The velocity of these droplets and of the vapour after this phase of creation of vapour is no longer in the direction of the flow and there was loss of a significant portion of the initial kinetic energy of the jet.
2. As this flash creation of vapour is very abrupt, it is very difficult to control and it seems that a good portion of the available energy is lost in this phase, in particular in the form of turbulence.
3. The vapour is then entrained in the common diverging nozzle 26, in which it is expanded. In this phase, the droplets have an initial velocity that is anarchic in direction and in intensity. There are therefore multiple collisions between droplets right from the beginning. These collisions lead to significant losses of energy. Under the effect of these collisions, the droplets coalesce and split. Experiments have shown that the average equilibrium diameter of the drops is about 500 microns under OTEC conditions. Now, the power transmitted between the vapour and the droplets is directly proportional to the drag force on the droplets in the vapour. This drag force is itself proportional to the section of the droplet, or to the square of its diameter, and to the sliding velocity between the vapour and the droplets. This sliding velocity must be limited, as the corresponding kinetic energy for the vapour is in the end lost. Acceleration that can be communicated to the droplets by the vapour is proportional to the drag divided by the mass of the droplet. The mass of the droplet is itself proportional to the cube of the diameter. Finally, therefore, the possible acceleration of the droplet is inversely proportional to the diameter of the droplet. For a diameter of 500 microns and a sliding velocity of 20 m/s, the possible acceleration is only 18 m/s², requiring an acceleration distance of at least 46 m. 100-micron droplets would allow an acceleration and a distance of 80 m/s² and 10 m respectively, whereas for 10-micron droplets the figures are 890 m/s² and 0.9 m respectively.
4. The pressure drops of the vapour/droplets two-phase flow in the acceleration part are very significant, compared with the available pressure difference. It is therefore essential to reduce the length of the acceleration zone 25 as much as possible. As was seen previously, the solution is to reduce the size of the droplets. Now, the droplets tend rapidly to a significant equilibrium diameter (500 microns) and the initial diameter is itself fixed by the diameter of the jet, which is difficult to reduce to below 100 microns, owing to the risks of clogging of the injection holes 21 (with a fluid such as seawater and risks of biofouling) and taking into account the pressure drops caused by the injection holes themselves.

It therefore appears that the mist generating device consisting of a plate 20 perforated with a plurality of holes 21 combined with an acceleration zone 25 as proposed in the prior art has serious constraints, which will drastically limit the efficiency of the device.

FIG. 6 shows, from the prior art, an expansion nozzle for a two-phase fluid. A nozzle comprises, successively in the direction of flow of the fluid, a converging portion 10, a neck 11 and a tube 12. The fluid in the liquid state is first accelerated in the converging portion 10 as far as the neck 11. At the outlet of the neck 11, vapour is produced by flash vaporization of the liquid. This vapour is guided in tube 12, which can be divergent with a half-angle (a) from the section of the neck 11 and flash vaporization is controlled by the geometric parameters of the diverging portion 12. Controlled flash vaporization is therefore obtained, with a vapour velocity represented by the arrows 13 possessing a principal component in the direction of flow. These two factors make it possible to communicate, very efficiently from the start of flash vaporization and in the direction of flow, the kinetic energy from the vapour to the droplets formed by the break-up of the jet as it leaves the neck 11 and to the droplets stripped from the jet by the vapour.

This type of nozzle is used in ejectors and it has also been proposed, in the prior art, to use it in rotating machines of the “Hero” turbine type, each arm 1 having a nozzle at the end.

However, the efficiency of expansion of the two-phase fluid is still mediocre owing to the fact that few droplets are stripped from the jet and the flow is divided in the tube part into a mainly liquid flow at the centre and a mainly vapour flow at the periphery. This is all the more true, the larger the diameter of the jet, limiting the thermal and mechanical exchanges between the vapour and liquid phases at the periphery of the jet.

In order to improve the efficiency of expansion, it has been proposed (document FR 2 944 460) to add a mixer element downstream of the neck. This mixer element 14, shown on a nozzle in FIG. 7, can be for example a fixed or movable helix.

This mixer element 14 provides efficient mixing of the liquid and vapour phases downstream of the neck 11 and thus improves the liquid/vapour mechanical coupling.

It should be noted, however, that these nozzles only make it possible to treat a very limited liquid flow. In fact, at constant pressure of the liquid, any increase in the flow rate passes through an increase in the section of neck 11 of the nozzle and therefore of the diameter of the jet immediately at the outlet of neck 11. It is clear that the increase in the diameter of the jet will reduce the efficiency of production of vapour during flash vaporization, as the exchange surface areas are reduced as a function of the mass of water, the thermal exchanges within the jet being more difficult, and will also reduce the efficiency of formation of microdroplets during break-up of the jet. Any increase in the liquid flow rate also means an increase in the flow rate of vapour produced. Now, in the case of OTEC, the very low density vapour requires very large sections for passage. The section of the nozzle at the outlet of tube 13 will therefore have to be very large. Now, in order to limit the pressure drops of the flow it is necessary to limit the half-angle (a) of the diverging portion of tube 12. A large outlet cross-section will therefore necessarily mean a considerable length of tube 12, a source of pressure drop of the flow and of major manufacturing difficulties. For example, a nozzle with a diameter at the neck of 0.10 m would allow the flow of 0.25 m³/s of hot water under a pressure of 4.5 bar. This flow rate would require a diameter at nozzle outlet of 2.7 m and a length of tube 12, limiting the half-angle of the diverging portion (a) to 5°, of 15.3 m. Moreover, heat exchange between the centre of the jet with a diameter of 0.1 m and the vapour would be very mediocre because of the small areas of contact. Finally, the low efficiency of the formation of microdroplets from the jet will limit the friction between vapour and droplets and will mean that a considerable acceleration length is required (for example a length of 46 m for drops with a diameter of 500 microns, whereas the length is 0.9 m for drops with a diameter of 10 microns).

It should also be noted that 80 nozzles of this type would be required for treating a flow rate of 20 m³/s of hot water corresponding to an OTEC power of 10 MW.

The production of energy in the context of OTEC using a “Hero” turbine, in which each arm 1 has a single nozzle of the type shown in FIGS. 6 and 7 at the end, therefore is not possible for powers of several MW, taking into account the flow rates to be treated.

FIG. 8 shows, in an embodiment, a diagram of the two-phase expansion device according to the invention, capable of maximizing the momentum produced by a two-phase flow. It is a sectional view, in which a support 61, in the form of a plate, is only partially shown.

A plurality of nozzles 60 each comprising at least one converging portion 65, one neck 66 and one tube 67, preferably diverging in the direction of flow of the fluid, are arranged adjacent on the support, side by side, so that the total flow of hot water to be treated is distributed to each of the nozzles 60. In the embodiment shown, the adjacent nozzles 60 are machined in a plate 61, which can be metallic or of any corrosion-resistant material possessing adequate mechanical properties. There can be mentioned for example steel, titanium or plastics or composites. Among the many possible embodiments, the assembly could be obtained by moulding or any other method. The nozzles 60 could also be produced separately, individually, and assembled on a suitable support, or else fixed to one another directly by welding or bonding, for example. Hot water, represented by the arrow 62, enters a receiver 63, the role of which is to distribute the water to the plurality of nozzles 60 while minimizing the pressure drops of the flow at the inlet of the nozzles 60. Turbulence attenuators can be fitted in the receiver 63.

Sealing means are placed between the nozzles 60, so that a fraction of the fluid flow passes through each nozzle 60, without circulation of fluid between the nozzles 60. The flow, represented by the arrows 64, passing through each nozzle 60 is therefore controlled by the number of nozzles 60 in the device. This number can be selected so as to be within a range of flow rates favourable to the operation of each nozzle 60, and so as to reduce the required length of the diverging tube 67 of each nozzle 60.

In fact, for one nozzle, it was seen that an increase in the flow passing through the nozzle leads among other things to an increase in the length of the diverging portion. According to the invention, by dividing the flow among the nozzles 60 for two-phase expansion, the latter can be adjusted by adapting the number of nozzles 60 available on the support.

The initial flash vaporization that corresponded in the plate device 20 with holes 21 of the prior art to a significant energy loss is used effectively in the device proposed in the present invention. In fact, the section of neck 66 is designed so that, under the conditions of pressure and temperature of use of the device, a jet or a sheet of liquid is obtained at the outlet of neck 66, in the diverging tube 67, where the two-phase expansion takes place, generating a mist of droplets in their vapour.

A mixer element, similar to that described with reference to FIG. 7, can be incorporated in the diverging tube 67 of some or all of the nozzles 60 for two-phase expansion.

In an embodiment, according to FIG. 8, the whole of the available expansion is carried out in each of the nozzles 60. The two-phase fluid leaving the nozzles 60 therefore consists of liquid droplets 68 accelerated and dispersed in the vapour. The expansion and acceleration of the droplets having been completed at the outlet of nozzles 60, this fluid will then be guided towards the devices downstream of recovery of the kinetic energy of the droplets and condensation of vapour in the case of the mist-lift technique and condensation of vapour and recovery of liquid in the case of the method using the principle of the “Hero” turbine. The arrows referenced 69 indicate the direction of movement of the droplets and of the vapour. To return to the preceding example of a 10-MW OTEC power station requiring a flow rate of hot water of 20 m³/s at an inlet pressure of 4.5 bar and limiting the angle (a) of the diverging portion to 5°, about 800 000 nozzles would be required with a neck diameter of 0.001 m with an outlet diameter of 0.025 m and a tube length of 0.12 m.

Thus, there is no of loss of kinetic energy by expansion of the vapour transversely to the arrows 29, the vapour having been created almost entirely by being guided in the diverging tubes 67 of the two-phase nozzles 60.

In another embodiment, according to FIG. 9, the expansion carried out in each of the nozzles 60 is only partial, so that the fluid leaving the nozzles 60 can be expanded further. A duct 70 with suitably varying section, forming a diverging portion common to the plurality of nozzles 60 for two-phase expansion, extends all of the nozzles 60 in the direction of flow of the fluid. The common diverging duct 70 makes it possible to complete the expansion of the two-phase fluid and complete the phase of acceleration of the droplets in an acceleration zone 71. This arrangement makes it possible both to perform the first part of expansion in the nozzles 60 under favourable conditions of efficiency with respect to this initial expansion and the fractionation of the jet into microdroplets, and with good guidance of the two-phase fluid, and to complete the expansion with a minimum pressure drop, by minimizing the wall surface areas.

Particular attention will be paid to limiting any abrupt change of sectional area of the section for passage of the vapour at the immediate outlet of the nozzles, in order to avoid expansion of the vapour transversely to the arrows 69.

Several configurations are possible for this, and there can be mentioned:
1. arranging the outlet section of the nozzles 60 so that there is little or no space between two adjacent nozzles 60. FIGS. 10a and 10b show, in top view and in partial sectional view respectively, an almost square outlet section 72 of the nozzles 60, making it possible to minimize the space between the nozzles 60. The section for passage of the vapour therefore has little variation at the immediate outlet of the nozzles, avoiding abrupt expansion, which is a source of pressure drop.
2. inserting extending elements 73 of variable section at the outlet of nozzles 60, providing continuity of the variation of section. A possible arrangement of this type of element is shown in top view and in partial sectional view in FIGS. 11a and 11b respectively. In this embodiment, the extending elements fill the space between and at the level of the outlets of the diverging tube 67 of nozzles 60. Their section then varies gradually.

FIGS. 11a and 11b show an embodiment in which the section of the extending elements 73 decreases gradually, allowing expansion of the vapour in the zone referenced 74. In an embodiment, the cold water required for condensation of the vapour produced can be ejected in the form of spray from these extending elements 73 by means of feed channels and suitable injectors. This arrangement makes it possible to condense the vapour nearest to the end of the droplet acceleration zone 71 and therefore decrease the pressure drops as well as introduce the cold water spray 75 into the two-phase flow with a large component of the initial velocity in the same direction as the two-phase flow so that only a single flow is obtained.

Similarly, when all of the expansion is carried out in nozzles 60, the cold water spray can be positioned in the available space between the outlets of nozzles 60, with a large component of the initial velocity in the same direction as the two-phase flow so that only a single flow is obtained.

The liquid jet leaving neck 66 of each nozzle 60 and then breaking up in the form of droplets can be of any section, and most often is circular. The shape of its section is generated by the shape of the section of the neck of the nozzle.

In the previous examples, the liquid leaving neck 66 is in the form of a jet, i.e. with all the dimensions of the flow in a plane perpendicular to the flow of the same order of magnitude. In fact, the section of neck 66, in a plane perpendicular to the flow of the liquid, is for example circular or square: the jet then has a circular or square section and all the dimensions of the flow in a plane perpendicular to the flow of the same order of magnitude.

FIGS. 12a and 12b show, in top view and in partial sectional view respectively, another embodiment in which the shape of the section of the neck 66 of nozzles 60 is arranged so as to produce and eject a liquid sheet instead of a liquid jet. A liquid sheet denotes a thickness of the liquid flow that is much less than its width. In this case, the section of neck 66 could, for example, be rectangular as shown in FIG. 12, as well as the section of the converging portion 65 and of the diverging tube 67 of the nozzles. This arrangement facilitates implementation of the nozzle assembly, the neck being an elongated slit 80, and makes it possible to reduce the number of nozzles 60 for one and the same flow rate, each nozzle 60 having a considerable length. This embodiment also makes it possible to minimize the space between nozzles 60 at the outlet of nozzles 60. Conversely, it causes a slight decrease in the areas in contact between liquid and vapour and the thermal exchanges.

The device thus formed for expanding a fluid then makes it possible to maximize the momentum produced by a two-phase flow. In fact, owing to guiding of the expansion of the vapour in the plurality of two-phase nozzles 60, on the one hand the flow rates with which the device can operate can be increased without increasing the length of the assembly and on the other hand the pressure drops due in particular to expansion of the vapour are reduced, and atomization of the liquid flow at the neck outlet is more effective, allowing smaller droplets and better vapour-liquid coupling to be obtained. The potential power supplied by the device, when it is incorporated for example in a device employing the mist-lift technique, is far greater than that obtained with the devices of the prior art.

The break-up (atomization) of the jet or of the sheet at the outlet of neck 66 of nozzles 60 is a very important factor in the efficiency of the device. In fact, the smaller the size of the droplets generated, the greater the mechanical coupling by friction between the liquid phase and the vapour phase, and the higher the efficiency of the whole.

Numerous arrangements or additional devices can be used in the device of the invention. The following can be mentioned, non limitatively:
modifying the geometry of the nozzles 60 or inserting elements making it possible to create pressure variations within the liquid jet, turbulence, velocity variations;
forcing the atomization by active methods such as assistance by ultrasound, the application of an oscillation of velocity or of pressure, the injection of electric charges, the injection of acoustic waves.

With the device according to the invention it is possible to create a two-phase flow very efficiently, maximizing the momentum created.

It is more particularly suitable for hot liquids with a low vapour density at the operating temperatures considered and/or for cases where the flow rates of hot liquid to be treated are very large.

It is particularly suitable for insertion at the end of the arms of a “Hero” turbine for driving it by reaction or for replacing the mist generator and the acceleration zone of the prior art in the mist-lift techniques.

A preferred application is Ocean Thermal Energy Conversion.

An example of use of the two-phase expansion device in a device utilizing a turbine of the “Hero” type will now be described.

FIG. 13 shows a first embodiment in sectional top view of a device converting thermal energy to mechanical energy, of the “Hero” type. It is supplemented with FIG. 14, which shows this same device of the “Hero” type in sectional side view. The drawings are purely diagrammatic and their function is to aid understanding of the device.

The conversion device forms part of an installation, which can comprise several conversion devices. The installation is in fluid communication on the one hand with a hot source of a so-called hot fluid and on the other hand with a cold source of a so-called cold fluid, the cold fluid being at a temperature below that of the hot fluid. In the examples described, the hot fluid and the cold fluid are water.

The conversion device comprises a chamber 100, delimiting an interior space. The chamber 100 has a so-called axis of rotation 103, fixed relative to chamber 100. When the installation is in place, the axis of rotation 103 is preferably approximately vertical.

The adjective “vertical” is to be understood here with reference to gravity, i.e. as denoting a direction parallel to gravity.

Hereinafter, “axial” will denote any direction parallel to the axis of rotation 103 and “transverse” will denote any direction perpendicular to the axis of rotation 103. Moreover, “radial” will denote, hereinafter, any direction, in a transverse plane, intersecting the axis of rotation 103, and “orthogonal” denotes any direction, in a transverse plane, not intersecting the axis of rotation, by reference to the components of a rotary speed about the axis of rotation 103.

For example, the chamber comprises a wall delimiting the interior space, and with section transverse to the axis of rotation 103 substantially circular or elliptical about the axis of rotation 103. The wall of the chamber 100 makes it possible to ensure hermeticity between the external atmosphere and the interior of the chamber 100, where a partial vacuum is maintained, for example of the order of 0.013 bar in the context of OTEC.

This chamber 100 can be manufactured in any material able to ensure strength and hermeticity. There can be mentioned, without this list being exhaustive, concrete, steel, composites among the possible materials, or a combination of these materials.

In view of the large dimensions of this chamber 100, preferably a shape will be adopted that can best withstand external pressure, such as shapes that are partly elliptical, hemispherical, cylindrical, etc.

The chamber 100 shown in FIGS. 13 and 14 can comprise flotation means, and can thus float on the surface of an ocean, or any other expanse of water, held completely submerged in between water currents by anchoring systems or kept partially submerged by anchoring systems so as to be free from the stresses of the swell.

It can also be a structure installed on the ground or installed and maintained at the bottom of an expanse of water when the height of water is not too significant, for example so as to avoid the need for an excessive length of pipe for the cold water feed.

The device comprises an inlet channel 112, for supplying and distributing hot water within the chamber 100. The arrow 113 represents the inflow of hot water in the inlet channel 112. The hot water is pumped at a first depth under the surface of the ocean, from a depth zone where the water is at a maximum temperature, generally between 0 and 100 m.

The conversion device comprises a distributor 150, in fluid communication with the hot source. More precisely, according to one embodiment, the distributor 150 comprises a first so-called central channel 102, extending along the axis of rotation 103, and in fluid communication with the inlet channel 112. The distributor 150 also comprises a second so-called inflow channel 104, extending transversely to the axis of rotation 103 starting from the central channel 102. As illustrated in particular in FIG. 13, the distributor comprises four inflow channels 104, distributed at 90° around the axis of rotation 103, each fixed rigidly to the central channel 102. The number and the distribution of the inflow channels 104 may, however, be otherwise. The inflow channels 104 can be straight or curved.

Thus, the hot water enters the inlet channel 112 and arrives at the inflow channels 104, passing via the central channel 102.

The hot water enters the central channel 102, which is mounted in rotation about the axis of rotation 103 with respect to chamber 100, and more precisely, with respect to the walls of the chamber 100.

A rotating seal 114 provides hermeticity between the inlet channel 112 and the central channel 102 while allowing their relative rotation.

Bearings 115 equipped with the necessary means, such as roller bearings, thrust bearings, etc., make it possible to maintain the central channel 102 substantially parallel to and in alignment with the axis of rotation 103.

The channels 102, 104, 112 can be made of any material making it possible to ensure mechanical strength of the assembly in particular with respect to centrifugal forces.

There can be mentioned for example, non limitatively, steel, aluminium, and composite materials.

The conversion device comprises at least one device 106 for two-phase expansion, according to the invention, fixed rigidly to the free end of an inflow channel 104, which forms an arm, making it possible to generate and accelerate a mist of water droplets in their own vapour, within the chamber 100. According to the example in FIGS. 13 and 14, the conversion device comprises four inflow channels 104 distributed around the axis of rotation 103, a device 106 for two-phase expansion according to the invention being fixed rigidly to the end of each arm 104.

Thus, the assembly formed by the central channel 102, the inflow channels 104, the devices 106 for two-phase expansion, which can optionally comprise a common diverging duct 70, is said to be rotating, as it turns about the axis of rotation 103 with respect to chamber 100. The rotation of the rotating assembly is represented by the arrow 111.

The water, under the effect of the rotation of the rotating assembly, acquires pressure, and the rotation of the rotating assembly is maintained by the acceleration of the mist leaving the devices 106 for two-phase expansion, which creates a thrust by reaction and causes rotation of the rotating assembly.

The rotation of the rotating assembly can, if necessary, be started by an auxiliary device, such as a motor or a pump putting the water under pressure in the inflow channel 104, and the power of which would be reduced as the rotary speed of the rotating assembly increases until a defined velocity is reached.

A rolling device can be combined with the rotating assembly. The rolling device is for example in the form of a set of wheels, making it possible to accompany the rotation of the rotating assembly in the chamber 100 about the axis of rotation 103. Optionally, the rolling device is retractable.

Hot water under pressure is received at the end of each inflow pipe 104 in the distributor 105 of the device 106 for two-phase expansion, the shape of which makes it possible to minimize the pressure drops due to the displacement of the water and to eject the water, under the effect of the pressure, through the nozzles 60 for two-phase expansion.

A mist 8 of droplets of liquid water dispersed in the vapour generated by their own partial evaporation is therefore obtained at the outlet of the nozzles 60 for two-phase expansion.

The assembly is then optionally guided in the common diverging duct 70, the suitable shape of which makes it possible to obtain complete expansion of the vapour up to the pressure prevailing within the chamber, of the order of 0.013 bar. Each common diverging duct 70 is oriented approximately to orthogonally to the axis of rotation 103 on the end free of the corresponding inflow channel 104, making it possible to generate a mist 8 of billions of droplets, the mist 8 of vapour and droplets having an initial velocity at the outlet of the device 106 for two-phase expansion represented by the arrows 109, the orthogonal direction of which is approximately opposite to the orthogonal component of the rotary speed 111 of the rotating assembly.

In the course of expansion, the vapour transforms its enthalpy into kinetic energy. The pressure and temperature of the vapour gradually decrease.

Bearing in mind the very low unit mass of the droplets, the forces of friction and of viscosity are far greater than the weight of the latter and allow significant acceleration of the droplets. The vapour therefore transmits a large part of its energy of expansion to the droplets. At the same time, as the vapour cools and the pressure decreases during expansion, the droplets continue on their path to produce vapour, allowing the vapour to reach nearly 2.6% of the liquid mass.

At the outlet of each device 106 for two-phase expansion, the droplets have therefore been accelerated by the vapour and have a velocity greater than the rotary speed of the rotating assembly.

More than 80% of the energy of expansion of the vapour can be transferred in the form of kinetic energy to the droplets.

As the mass of the droplets represents nearly 98% of the total mass of the mist, this kinetic energy only allowed the velocity of the droplets to increase slightly, whereas if the vapour had been expanded on its own, it would have reached very high exit velocities in view of its small mass.

Now, it is known that to obtain high efficiencies, it is desirable for the velocity of the fluid leaving the device 106 for two-phase expansion to be as close as possible to the peripheral velocity due to the rotation, in order to minimize the absolute velocity of the fluid at the outlet.

Thus, the efficiency of the conversion device can be above 75%, depending on the conditions.

At the outlet of the devices 106 for two-phase expansion, the vapour and liquid phases separate, the vapour flow 128 being aspirated by the low pressure prevailing at the level of the condensation means 116 within the chamber 100, because of a vacuum pump 119 installed downstream of the condensation means 116 relative to the circulation of the vapour within the chamber 100. The vacuum pump 119 makes it possible, moreover, to maintain the partial vacuum within the chamber 100 while evacuating the non-condensable gases and the portion of the vapour that would not have condensed (arrow 126).

These condensation means 116 must allow condensation by direct and/or indirect heat exchange with cold seawater originating from the depths, and more precisely at a second depth, greater than the first depth from where the hot water is pumped. According to the embodiment presented, the condensation means 116 comprise a set of channels 117 for feeding cold water 127 into the chamber 100 and a system 118 for spraying the cold water onto the vapour so that it condenses.

The spraying system 118 can be a combination of different systems with cross flows, counter-flows, etc.

The condensation means 116 can be composed entirely or partly of indirect exchangers between the cold water and the vapour making it possible, if desired, to produce fresh water from the vapour by recovering its condensed phase.

A means for recovering and evacuating this fresh water will then have to be added in order to avoid any contamination by the cold seawater.

In the configuration presented in FIGS. 14 and 16, a recuperator 120 makes it possible to recover the cold water and the condensed vapour together and a pump 121 allows them to be evacuated outside of the chamber 1 (arrow 125). Likewise, a recuperator 122 allows the hot water to be recovered and a pump 123 makes it possible to evacuate it outside of the chamber (arrow 124).

In this configuration, a generator 131 is also shown, making it possible to transform the mechanical energy of rotation of the rotating assembly into electrical energy. This is a rotating linear alternator 131 directly coupled to the upper part of the rotating central channel 102, for example of the type installed on wind turbines. This choice makes it possible to do without a very expensive reduction gearbox and appears to be useful in view of the rotary speeds envisaged. This alternator 131 can of course be installed within the chamber 100 or outside it, provided the central channel 102 is extended by a rotating shaft. A conventional generator/reduction gearbox system can also be considered.

It is also possible to envisage recovering the mechanical energy of rotation of the rotating assembly and transforming it into electrical energy by means of a hydroelectric generating set 133.

For example, the hydroelectric generating set 133 can be inserted into the central hot fluid pipe 102 when the latter arrives under pressure as illustrated in FIG. 16. As a variant, several hydroelectric generating sets can be fitted in each of the inflow pipes 104, utilizing the pressurization generated by the rotation of the rotating assembly.

It is also possible to envisage that only hydraulic helices or wheels are inserted into each of the inflow pipes 104, a transmission system making it possible to direct all of the mechanical energy collected to a single generator.

It is also conceivable to fix one and the same device 106 for two-phase expansion on several inflow pipes 104, i.e. the distributor 105 of a device 106 for two-phase expansion is supplied with water by several inflow pipes 104.

FIG. 15 shows a diagrammatic view of the rotating assembly and in particular of its elements 104, 105, 60 and 70.

It is very important for the efficiency of the device to minimize the pressure drops in the inflow channels 104 and the distributor 105 of each device 106 for two-phase expansion. The appropriate shapes and sections for this requirement will therefore be selected for these elements.

Similarly, the device 106 for two-phase expansion must have a minimum pressure drop. The shape of the nozzles 60 for two-phase expansion, their diameter, their spacing, and their material will also be adapted to meet this requirement.

The formation of a plurality of micro-jets at the outlet of the device 106 for two-phase expansion makes it possible to create the mist in which the continuous phase is the vapour 108 and the dispersed phase is the droplets.

This multitude of droplets has an area of contact with the vapour that is very favourable for heat exchange.

An angle A between the orthogonal velocity 111 due to the rotation of the rotating assembly and the velocity 109 of ejection of the fluid at the outlet of the mist generator 106 is shown in FIG. 15. It is in fact necessary to avoid having the liquid droplets, after they are ejected from the device 106 for two-phase expansion, strike the receiver 105 of the following device 106 for two-phase expansion in the direction of rotation.

One possible solution is to use a non-zero angle A, so that the liquid droplets are ejected with a component towards the periphery sufficient to avoid them striking the receiver 105 of the following device 106 for two-phase expansion. This angle will have to be minimum in order to minimize the resultant loss of power. An angle from 5° to 15° may be suitable in certain configurations.

Ejection in any other direction than the periphery might also be suitable provided it makes it possible to avoid any collision with the rotating assembly.

For a better understanding of all of the advantages offered by the conversion device equipped with the device 106 for two-phase expansion according to the present invention, it is useful to present the details of a numbered embodiment example of such a device.

It should be noted that the numerals indicated above are given purely as a guide and largely depend on the chosen hypotheses.

Consider the device 106 for two-phase expansion according to the present invention used in the context of OTEC with a hot water temperature of 25° C. and a cold water temperature of 8° C. at the inlet of the conversion device.

The flow rates are 6.5 m³/s for the hot water and the cold water.

The conversion device has a radius of the rotating assembly of 20 m for a rotary speed of 2 rad/s (radians per second).

The peripheral velocity due to the rotation is 40 m/s.

Assuming optimized geometry, the pressure of the hot water due to the rotation is 8.4 bar in the receiver 105 of the devices 106 for two-phase expansion, leading to an ejection velocity 109 of 54 m/s at the outlet of the devices 106 for two-phase expansion.

For a droplet diameter of 0.2 mm corresponding to nozzles 60 for two-phase expansion with a diameter of 0.1 mm and an average sliding velocity between droplets and vapour of 80 m/s, the forces of friction and of viscosity acting on each droplet are 10 times greater than the weight of each droplet, giving an acceleration of the droplets of nearly 230 m/s².

The mechanical power returned is 3500 kW.

Firstly, it can be seen that the outlet velocity of the droplets, which represents 98% of the mass ejected, is close to the peripheral velocity, which makes it possible for the conversion device to have excellent efficiency.

A conventional conversion device with a steam turbine or two-phase turbine without significant liquid phase/vapour coupling would lead to vapour velocities of nearly 400 m/s.

In order to obtain equivalent peripheral speeds, it would then be necessary to have very high rotary speeds, leading in consequence to centrifugal forces that are unacceptable for the rotating elements.

The conversion device presented, equipped with devices 106 for two-phase expansion according to the invention, therefore makes it possible, while maintaining high efficiency, to limit the rotary speeds and the centrifugal forces, owing to excellent mechanical coupling of the liquid phase and vapour phase.

The dimensions, the rotary speeds, the masses and the centrifugal forces are still within the ranges of values encountered in medium-power wind turbines.

In the example considered, the exit velocities of the device 106 for two-phase expansion are still, however, high enough (about 60 m/s) in order to allow reasonable dimensions of the device 106 for two-phase expansion.

The conversion device makes it possible to select the rotary speed and the radius of the rotating assembly, as well as the sizes of the droplets produced and the dimensions of the device 106 for two-phase expansion, and in particular the dimensions of the nozzles 60 for two-phase expansion and the length of the common diverging duct 70, making to possible to find the best compromise between the following constraints:
high exit velocities of the device 106 for two-phase expansion, allowing limited sections,
good vapour/water coupling for good efficiency and
acceptable centrifugal forces, to mention just some of the criteria.

The length of travel of the droplets in the conversion device proposed is very limited, limiting the number of collisions between droplets and with the walls, which is a significant source of energy losses, in contrast to the conversion devices proposing vertical lift of the liquid phase requiring a travel of nearly 100 m.

It avoids the expensive, gigantic indirect heat exchangers of the closed-cycle solutions and only requires materials that are available everywhere, which are inexpensive and have few constraints on manufacture.

An example of the use of the two-phase expansion device according to the present invention in a device using a turbine of the impulse type, for example a turbine of the Pelton type, will now be described.

The use of the two-phase expansion device according to the present invention will be described below in a Pelton turbine; use in another type of impulse turbine can easily be deduced from the latter.

A Pelton turbine utilizes the kinetic energy of a liquid jet produced by one or more injectors to produce mechanical energy. The function of the injector is to transform the pressure energy of the water into kinetic energy.

The two-phase expansion device according to the present invention transforms the thermal energy of a hot fluid into kinetic energy in the form of accelerated droplets and vapour. The use of the two-phase expansion device in place of an injector makes it possible to propel a flow of droplets and vapours at high velocity onto the buckets of a Pelton turbine. In order to maintain good efficiency, the shape and size of the buckets and the characteristic sizes of the Pelton turbine can be adapted appropriately. Several devices for two-phase expansion can be used for one and the same Pelton turbine wheel.

The two-phase expansion device proposed according to the invention makes it possible to transform the thermal energy contained in two fluids with a small temperature difference, into mechanical energy very efficiently and with a simple and inexpensive device.

It is particularly suitable for ocean thermal energy conversion, for geothermal energy and for recovery of industrial waste heat.

1-18. (canceled)

19. A device for two-phase expansion capable of maximizing the momentum produced by a two-phase flow originating from the expansion of a significant saturation flow rate of a fluid originating from a so-called hot source, the device for two-phase expansion comprising at least:
one distributor making it possible to distribute said fluid originating from said hot source to a plurality of nozzles for two-phase expansion;
said plurality of adjacent nozzles for two-phase expansion with substantially parallel axes, each nozzle for two-phase expansion comprising successively at least one converging portion, one neck and one tube and said nozzles for two-phase expansion being arranged so that each receives a portion of said flow originating from said hot source;
means making it possible to hold said plurality of nozzles for two-phase expansion in place and comprising impervious separating means between said nozzles for two-phase expansion.

20. The device according to claim 19, wherein said neck of said at least one nozzle for two-phase expansion is designed to produce a liquid jet.

21. The device according to claim 20, wherein said neck is of circular or square shape.

22. The device according to claim 19, wherein said neck of said at least one nozzle for two-phase expansion is designed to produce a liquid sheet.

23. The device according to claim 22, wherein said neck is in the form of an elongated slit.

24. The device according to claim 19, wherein at least one of said nozzles for two-phase expansion comprises a mixer element downstream of said neck.

25. The device according to claim 19, wherein all of the expansion of said saturation flow rate is carried out in each of said nozzles for two-phase expansion.

26. The device according to claim 19, wherein only a portion of the expansion of said saturation flow rate is carried out in each of said nozzles for two-phase expansion, the rest of the expansion being carried out in a duct forming a common diverging portion extending the assembly of said nozzles for two-phase expansion.

27. The device according to claim 19, wherein a space between said nozzles for two-phase expansion at said tube outlet is minimized by means of a suitable nozzle outlet geometry, so that the outlet of said tube of a first nozzle for two-phase expansion is in contact with the outlet of said tube of a second nozzle for two-phase expansion adjacent to said first nozzle for two-phase expansion.

28. The device according to claim 25, wherein liquid obtained from a so-called cold source, at a temperature below that of said hot source, and intended to condense the vapour produced, is ejected in the form of a spray from an available space between said nozzles for two-phase expansion at said outlet of the tube of said nozzles for two-phase expansion with a large/powerful velocity component in the direction of said two-phase flow leaving said nozzles for two-phase expansion.

29. The device according to claim 26, comprising extending elements of variable section at said outlet of said tube of said nozzles for two-phase expansion, providing continuity of a variation of section of said two-phase flow from said outlet of said tube of said nozzles for two-phase expansion to an outlet of said duct forming a common diverging portion extending said nozzles for two-phase expansion.

30. The device according to claim 29, wherein liquid obtained from a so-called cold source, at a temperature below that of said hot source, and intended to condense the vapour produced, is ejected in the form of spray from said extending elements with a large/powerful velocity component in the direction of said two-phase flow leaving said duct extending said tube of said nozzles for two-phase expansion.

31. The device according to claim 19, wherein said means making it possible to hold said plurality of nozzles for two-phase expansion in place comprises a plate, said nozzles for two-phase expansion being machined in said plate or moulded with said plate.

32. The device according to claim 19, wherein said means making it possible to hold said plurality of nozzles for two-phase expansion in place comprises means for welding or for bonding said nozzles for two-phase expansion together.

33. A turbine of the “Hero” type, having arms comprising at least one two-phase expansion device at the end of at least one of said arms, wherein said two-phase expansion device comprises at least:
one distributor making it possible to distribute said fluid originating from said hot source to a plurality of nozzles for two-phase expansion;
said plurality of adjacent nozzles for two-phase expansion with substantially parallel axes, each nozzle for two-phase expansion comprising successively at least one converging portion, one neck and one tube and said nozzles for two-phase expansion being arranged so that each receives a portion of said flow originating from said hot source;
means making it possible to hold said plurality of nozzles for two-phase expansion in place and comprising impervious separating means between said nozzles for two-phase expansion.

34. A turbine of the impulse type, comprising at least one two-phase expansion device used as an injector, wherein said two-phase expansion device comprises at least:
one distributor making it possible to distribute said fluid originating from said hot source to a plurality of nozzles for two-phase expansion;
said plurality of adjacent nozzles for two-phase expansion with substantially parallel axes, each nozzle for two-phase expansion comprising successively at least one converging portion, one neck and one tube and said nozzles for two-phase expansion being arranged so that each receives a portion of said flow originating from said hot source;
means making it possible to hold said plurality of nozzles for two-phase expansion in place and comprising impervious separating means between said nozzles for two-phase expansion.

35. A device for converting thermal energy to mechanical energy using the mist-lift technique, comprising at least one two-phase expansion device for producing and accelerating droplets of a hot liquid, the conversion device using the mist-lift technique comprising means for fluidic connection with a hot source and means for fluidic connection with a cold source, wherein said two-phase expansion device comprises at least:
one distributor making it possible to distribute said fluid originating from said hot source to a plurality of nozzles for two-phase expansion;
said plurality of adjacent nozzles for two-phase expansion with substantially parallel axes, each nozzle for two-phase expansion comprising successively at least one converging portion, one neck and one tube and said nozzles for two-phase expansion being arranged so that each receives a portion of said flow originating from said hot source;
means making it possible to hold said plurality of nozzles for two-phase expansion in place and comprising impervious separating means between said nozzles for two-phase expansion.

36. The conversion device according to claim 35, wherein said hot source is hot water at a first depth under the surface of the ocean and said cold source is cold water at a second depth greater than the first depth under the surface of the ocean.
